(19) United States
(12) Patent Application Publication
(10) Pub. No.: US 2019/0292382 A1
(43) Pub. Date: Sep. 26, 2019

(54) FORMULATIONS FOR ELECTROSTATIC SPRAY ON NONCONDUCTIVE SUBSTRATES

(71) Applicant: CHEMICAL DYNAMICS LLC, Plymouth, MI (US)

(72) Inventors: Atman Fozdar, Ypsilanti, MI (US); Ronald Lewarchik, Brighton, MI (US)

(21) Appl. No.: 16/364,466

(22) Filed: Mar. 26, 2019

Related U.S. Application Data
(60) Provisional application No. 62/648,199, filed on Mar. 26, 2018.

(51) Int. Cl. C09D 5/24; C09D 7/40; C09D 123/28

(52) U.S. Cl. CPC C09D 5/24; C08K 3/041; C09D 123/28; C09D 7/67

(57) ABSTRACT

A conductive substance for the promotion of adhesion of liquid and powder coatings to non-conductive substrates is provided that includes a solvent. A chlorinated polyolefin dispersed is dispersed in the solvent along with conductive nanoparticulate. A process of applying a conductive adhesion promoter to a non-conductive substrate is also provided that includes the application of this conductive adhesion promoter to a non-conductive substrate. The surface resistivity the substrate with a cured, dried film of the conductive adhesion promotor is less than 10⁶ Ohm/Square. The conductive adhesion promotor cures and dries at an ambient temperature of 20° C. (1 atm) in 3-8 minutes. A dried film on a non-conductive substrate is also provided that has a cured matrix of chlorinated polyolefin in which conductive particulate is dispersed.

### RELATED APPLICATIONS

This application claims priority benefit of U.S. Provisional Application Ser. No. 62/648,199 filed 26 Mar. 2018; the contents of which are hereby incorporated by reference.

### FIELD OF THE INVENTION

The present invention in general relates to a formulation and in particular to conductive treatment for the promotion of adhesion of liquid and powder coatings to plastics, thermoplastic polyolefins, and other non-conductive substrates.

### BACKGROUND OF THE INVENTION

The economic and environmental pressures to produce vehicles that are lighter and stronger have only accelerated in the past few years. While weight savings were traditionally achieved by migrating from steel components to aluminum, even with the resort to newly engineered structures with reinforced stress points to account for the use of less metal, the ability to glean additional weight saving from aluminum components is diminishing.

Light vehicles represent an important market for plastic and polymer composites, one that has grown significantly in the last five decades. Among the reasons for the use for plastic and polymer composites are weight reduction, an inexpensive alternative to their metal counterparts, ability to mold complex geometries, and an increase in fuel economy due to reduced weight. Various plastics and composites are used for automotive interior, exterior, automotive electrical systems, powertrain components, and engine components. Due to the complex geometry and non-conductive nature of substrates formed with plastics and polymer composites, it is not possible to apply powder coating using electrostatic spray, and this limits the method of applying coatings to conventional liquid spraying methods There is significant loss in transfer efficiency (about 40-60% depending on geometry of the substrate) and inferior interfacial adhesion due to low surface energy of plastic composites when using conventional liquid coating spray methods. Hence there's a need to make application processes more efficient by improving transfer efficiency, interfacial adhesion and deposition of coating material onto the substrate.

Therefore, a major issue which confronts the coatings and ink industry is the adhesion of liquid and powder coatings to plastics and especially to thermoplastic polyolefins. There are several conventional approaches such as flame treatment, corona discharge, gas plasma, UV exposure, or chemical oxidation which may be used to oxidize the surface of the substrate to promote adhesion. Oxidizing the surface increases polar contribution to surface energy and produces more polar sites for bonding without altering the dispersive contribution significantly. The coating is best applied soon after treatment because the oxidation produces short lived radical species and is partially reversible with time. A major difficulty with above ‘radiative’ techniques is achieving uniform surface coverage without over-treating, which introduces chain-scission and can lead to cohesive failure within surface of the substrate. Furthermore, not all plastic substrates can withstand high curing temperatures of 160-200° C. of conventional powder coating. Many plastics are thermoplastic and tend to soften, degrade or even melt at such high temperature. Therefore, it would be safer to apply and cure a liquid and powder coating below the heat distortion or deflection temperature of a plastic substrate. Heat deflection temperature is a measure of polymer's ability to bear a given load at elevated temperatures. Table 1 summarizes heat deflection temperatures for different plastics and the types of powder coatings which can be used.

TABLE 1
Heat deflection temperature of different plastics and
types of liquid or powder coatings which can be used.

| | Heat Deflection | Type of liquid or powder coating |
|---|---|---|
| | temperature | which can be applied without |
| | at 0.46 | damaging plastic composite |
| Polymer type | MPa (° C.) | during curing of powder. |
| ABS | 98 | Liquid |
| ABS + 30% | 150 | UV, low temp. cure powder |
| Glass fiber | | or liquid |
| Nylon 6 | 160 | UV, low temp. cure powder |
| | | or liquid standard |
| Nylon 6 + 30% | 220 | UV, low temp. cure liquid |
| Glass fiber | | or powder, standard |
| Polycarbonate | 140 | UV, low temp. cure liquid |
| | | powder |
| PET + 30% | 250 | UV, low temp. cure liquid |
| Glass fiber | | or powder, standard |
| Polypropylene + 30% | 170 | UV, low temp. cure liquid |
| Glass fiber | | or powder, standard |
| Polycarbonate/ABS | 150 | UV, low temp. cure liquid |
| composite (70:30) | | or powder |
| Wood plastic | 150 | UV, low temp. cure liquid |
| composite | | or powder |

Recent advancements in the formulation of powder coatings, has provided powder coatings that may be applied to temperature sensitive surfaces and cure at low temperatures using infra-red (IR) or ultraviolet (UV) cure. Powder coating has been identified as a suitable and eco-friendly coating for plastics due to several reasons including: no volatile organic compound (VOC) emissions; high transfer efficiency (up to 90-95%, in case of conductive plastics); overspray can be reused; superior film properties (tough, durable, hard, scratch resistant); reduced process time and energy requirements; and a one-step finishing process.

However, the challenge still remains with the electrostatic application of powder and liquid coatings that enables acceptable adhesion to non-traditional substrates such as medium-density fiberboard (MDF), plastics, composites, glass, ceramic, etc. and achieve good transfer efficiency. In particular, challenges to powder coat plastics and composites include: application of powder coating using electrostatic spray on non-conductive surfaces of plastics and composites; adhesion of powder coating on plastics with low surface energy; and selecting the right chemistry of powder which cures at low temperature due to low heat deflection temperatures of powder coatings.

Treatments conventionally used to enhance surface conductivity include utilization of quaternary ammonium salts dispersions (QAS), carbon black, carbon fibers, indium tin oxide (ITO) based additives, silver nano particles or silver fibers, and metal nano particles (stainless steel particles). While QAS renders a coated substrate conductive, the treated substrates are humidity/moisture sensitive and temperature dependent as the QAS conductive treatment are water sensitive and migratory. The migratory nature of QAS doesn't ensure sufficient adhesion of a top coat to a substrate or flexibility. The use of conductive carbon black requires a significantly high loading of carbon black to get a low enough surface resistivity so that uniform film formation of powder coating can be achieved. Carbon fibers show anisotropic behavior and poor charging of powder particles when tribo spray gun is used. Issues such as limited colorability and higher specific gravity are encountered when metallic additives are used.

Table 2 summarizes surface resistivity of coated substrates using different types of conductivity agents at various loadings. Surface resistivity (Ohm/Sq) was measured using Monroe Electronics Model 272A as well as ED™ RC2175 for systems which were conductive, as per ASTM D257. Experiments conducted during the formation of Table 2 found that an increase in the conductive agent loading beyond a certain point that the resulting decrease in surface resistivity doesn't necessarily need to be substantial or linear. Hence, there is a need to find the optimum amount for each type of substrate i.e. porous (such as MDF) and non-porous (polycarbonate, PC/ABS, glass and wood plastic composite which is less porous comparatively).

TABLE 2
Surface resistivity of coated substrates using different
types of conductivity agent at various loadings.

| | | | Surface |
|---|---|---|---|
| | Type of | % Loading | resistivity |
| | conductivity | on total | (Ohm/Sq) |
| Substrate | agent | solids | ASTM D257 |
| MDF | QAS | 2 | 3.0 × 10¹³ |
| | | 4 | 1.5 × 10¹³ |
| | | 6 | 8.0 × 10⁹ |
| | | 8 | 3.0 × 10⁸ |
| | | 10 | 1.4 × 10⁸ |
| | Graphene | 2 | 3.7 × 10⁷ |
| | Carbon black | 2 | 6.1 × 10¹² |
| | | 5 | 7.2 × 10⁹ |
| Polycarbonate | QAS | 2 | 1.2 × 10¹³ |
| | | 4 | 4.6 × 10⁹ |
| | | 6 | 1.9 × 10⁹ |
| | | 8 | 1.1 × 10⁹ |
| | | 10 | 4.5 × 10⁸ |
| | Carbon black | 2 | 5.1 × 10¹⁰ |
| | | 5 | 3.6 × 10⁸ |
| | Conductive | 0.1 | 3.2 × 10⁹ |
| | Nano particle* | 0.2 | 5.7 × 10⁶ |
| | | 0.3 | 3.9 × 10⁴ |
| | | 0.33 | 2.1 × 10³ |
| PC/ABS | Conductive | 0.1 | 1.9 × 10⁸ |
| composite | Nano particle* | 0.2 | 5.1 × 10⁵ |
| | | 0.3 | 8.9 × 10⁴ |
| | | 0.33 | 1.1 × 10³ |
| Wood plastic | Conductive | 0.2 | 5.1 × 10⁵ |
| composite | Nano particle* | 0.33 | 1.1 × 10³ |

For successful application of liquid and powder coatings (uniform appearance, film formation, and deposition of powder particles on a substrate as well as in recess areas where there is no direct line of sight at the time of application) on plastic substrates, surface resistivity of a substrate is required to be less than 10⁸ Ohm/Square (Fozdar A., Mannari V. “Development of Low VOC Static Dissipative Coating for Powder Coating Non-Traditional Substrates.” European Coatings Journal, April 2017). However, insufficient and/or non-uniform surface treatment of these substrates prior to application results in a non-uniform finish, multiple film defects, and poor transfer efficiency

Thus, there exists a need for a substance and treatment for the promotion of adhesion of liquid and powder coatings to plastics, thermoplastic polyolefins, and other low conductive substrates that does not render the coated material moisture sensitive, affect mechanical properties of the coating, lower impact strength or produce sloughing, marking and crayoning effect.

### SUMMARY OF THE INVENTION

A conductive substance for the promotion of adhesion of liquid and powder coatings to non-conductive substrates is provided that includes a solvent. A chlorinated polyolefin dispersed is dispersed in the solvent along with conductive nanoparticulate. A process of applying a conductive adhesion promoter to a non-conductive substrate is also provided that includes the application of this conductive adhesion promoter to a non-conductive substrate. The surface resistivity the substrate with a cured, dried film of the conductive adhesion promotor is less than 10⁶ Ohm/Square. The conductive adhesion promotor cures and dries at an ambient temperature of 20° C. (1 atm) in 3-8 minutes. A dried film on a non-conductive substrate is also provided that has a cured matrix of chlorinated polyolefin in which conductive particulate is dispersed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A shows an uncoated polycarbonate/ABS composite;

FIG. 1B shows a polycarbonate/ABS composite coated with a UV curable powder coating in accordance with an embodiment of the invention;

FIGS. 2A-C shows an uncoated wood-plastic composite (WPC) in front (FIG. 2A), back (FIG. 2B), and side (FIG. 2C) views;

FIGS. 2D-E shows the wood-plastic composite of FIGS. 2A-C with a partial UV curable powder overcoating over an inventive dried film in accordance with an embodiment of the invention in front (FIG. 2D), back (FIG. 2E), and side (FIG. 2F) views; and

FIG. 3 illustrates the results of a pull off adhesion test in accordance with an embodiment of the invention.

### DESCRIPTION OF THE INVENTION

The present invention has utility as a substance and treatment for the promotion of adhesion of liquid and powder coatings to plastics, thermoplastic polyolefins, and other non-conductive substrates. Embodiments of the invention provide rapid drying conductive adhesion promoters (CAPs) that improve adhesion of powder and liquid coatings to nonconductive substrates illustratively including acrylonitrile butadiene styrene (ABS), polycarbonate, Noryl GTX™, SMC, and polyolefinics, etc. Embodiments of the inventive CAPs improve transfer efficiency by dissipating static charge. The ability of embodiments of the inventive CAP to dry quickly permits application in a continuous/conveyorized production line followed by the application and curing of powder and liquid coatings to the CAP treated substrate. The use of CAPs in the substrate coating process eliminates the need for preheating, plasma treatment and chemical etching of plastic substrates while improving both film appearance and application efficiency. UV curable powder as well as low temperature cure (LTC) powder and liquid coatings can now be electrostatically applied uniformly even in recess areas and faraday cage areas. Embodiments of the inventive CAPs utilize novel conductive materials in conjunction with a polymeric adhesion promoter and at the same time improves flexibility and interfacial adhesion along with anti-static properties.

In embodiments of the invention, amount of chlorinated material in an adhesion promotor determines the compatibility with various paint systems. Once the chlorinated polyolefin (isotactic polypropylene) is dispersed with conductive nano particles to form the CAP, the CAP associates with plastics and composite substrates via dispersion interaction and thus adheres to the substrate. Chlorinated material and grafted functional groups (maleic-anhydride) add polarity to the CAP which promotes interfacial adhesion to substrate and a powder or liquid top coat.

The following are some of the benefits of using the inventive CAPs:
CAPs ensure sufficient dissipation of electric charge of negatively or positively charged powder particles applied by electrostatic spray equipment (corona or tribo respectively) as well as promote interfacial adhesion.
CAPs work more efficiently at lower film thickness on non-porous substrates. On porous substrates higher film thickness may be required since some of the material would be absorbed by porous substrate.
CAPs enable successful application of powder coating on various plastic composites (uniformity, film formation, ability to coat recess areas, etc.).
CAPs can significantly increase transfer efficiency of applying liquid or powder coating to plastic composites having a complex geometry.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

The CPO (chlorinated polyolefin) may be solvent or water based. Conductive nano particulate operative herein illustratively includes graphene, carbon nano tubes (multiwalled as well as single walled), and metallic nanoparticles having a mean particle size of 2 to 200 nm. There may be a need to add a surfactant, a dispersing agent, coalescing agent, deaerator, polyaziridine or carbodiimide type crosslinker and a stabilizer to achieve fine and stable dispersion of carbon nano tubes and/or graphene when using waterbased CPO as well as desired mechanical and physical properties like early hardness, adhesion and chemical properties like Methyl Ethyl Ketone or solvent resistance.

### Application of CAP and Powder Coating:

CAPs (solventborne or waterborne) were applied on substrates including wood-plastic composite, polycarbonate (PC)/ABS, and MDF and polypropylene substrates at 10-25 microns dry film thickness using a high-volume low pressure (HVLP) spay gun at 20 psi air pressure at the nozzle. The treated substrates were dried and cured at ambient temperature of 20° C. (1 atm) for 2-5 minutes for solventborne CAP and 5-8 minutes for waterborne CAP.

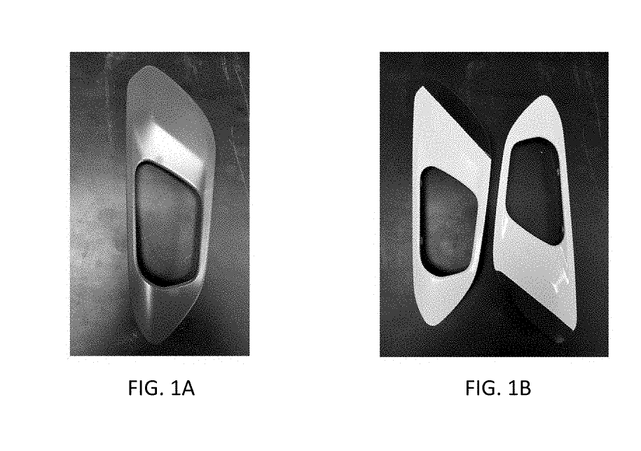

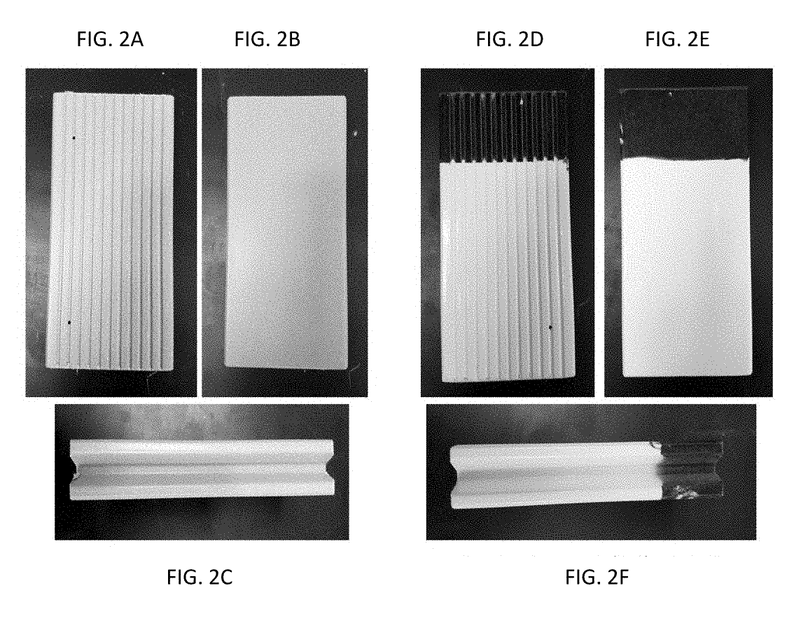

UV curable smooth, white epoxy powder coating was applied using an electrostatic spray gun on substrates coated with CAP. FIG. 1A shows an uncoated polycarbonate/ABS composite, while FIG. 1B shows a polycarbonate/ABS composite coated with a UV curable powder coating. FIGS. 2A-C shows an uncoated wood-plastic composite (WPC), while FIGS. 2D-E shows a wood-plastic composite with UV curable powder overcoating over an inventive dried film on the same WPC substrate shown in FIGS. 2A-C.

The present invention is further detailed with respect to the following non-limiting examples. These examples are exemplary of specific embodiments of the present invention and not intended to limit the scope of the appended claims. Unless otherwise specified, amounts are provided in total weight percentages.

### EXAMPLES

### Example 1

An inventive composition is provided and designated as SB-CAP1 and includes 10-25% CPO. 0.1-0.4% conductive nano particle, 25-65% Xylene and 3-10% Ethyl Benzene.

### Example 2

An inventive composition is provided and designated as WB-CAP1 and includes 10-35% CPO, 0.23-0.4% conductive nano-particle and 25-65% water.

### Example 3

An inventive composition is provided and designated as WB-CAP2 and includes 25-55% self crosslinkable aliphatic polymer, 0.33-0.5% conductive nano-particle, 25-65% water.

### Example 4

An inventive composition is provided and designated as WB-CAP3 and includes 23.5-53.78% self crosslinkable aliphatic polymer, 0.33-0.5% conductive nano-particle, 25-65% water and 1-3% polyaziridine.

### Example 5

An inventive composition is provided and designated as WB-CAP4 and includes 23.5-53.78% self crosslinkable aliphatic polymer, 0.33-0.5% conductive nano-particle, 25-65% water, 1-3% polyaziridine and 1-5% β-(3,4-epoxycyclohexyl) ethyltrialkoxysilane.

### Example 6

An inventive composition is provided and designated as WB-CAP5 and includes 23.5-53.78% self crosslinkable aliphatic polymer, 0.33-0.5% conductive nano-particle, 25-65% water and 0.25-4% β-(3,4-epoxycyclohexyl) ethyltrialkoxysilane.

### Example 7

An inventive composition is provided and designated as WB-CAP6 and includes 23.5-53.78% self crosslinkable aliphatic polymer, 0.33-0.5% conductive nano-particle, 25-67.34% water and 1-13.3% CPO.

### Example 8

An inventive composition is provided and designated as WB-CAP7 and includes 23.5-53.78% self crosslinkable aliphatic polymer, 0.33-0.5% conductive nano-particle, 15-51.79% water and 1-13.3% CPO.

### Example 9

An inventive composition is provided and designated as WB-CAP8 and includes 23.5-52.33% self crosslinkable aliphatic polymer, 0.33-0.5% conductive nano-particle, 15-51.79% water and 1-13.3% CPO.

### Example 10

An inventive composition is provided and designated as WB-CAP9 and includes 23.5-52.33% self crosslinkable aliphatic polymer, 0.33-0.5% conductive nano-particle, 15-51.79% water and 0.01-5% 2,2,4-Trimethyl-1,3-pentanediol monoisobutyrate.

Table 3 summarizes the results of crosshatch adhesion test and pull-off adhesion test of WBCAP variations 1-9 described in examples 2-10.

TABLE 3
ASTM D3359 Crosshatch adhesion (1 mm) and ASTM
D4541 Positest AT-A Pull off adhesion test

| | | | ASTM D4542 Positest pull-off | |
|---|---|---|---|---|
| | ASTM D3359 Crosshatch adhesion | | adhesion test (bond strength in | |
| | test (1 mm crosshatch) | | pounds per square inch.) | |
| WB-CAP Variations | Polypropylene | Polycarbonate | Polypropylene | Polycarbonate |
| WB-CAP1 | 0B | 1B | 99 | 177 |
| WB-CAP2 | 0B | 0B | NA (coating | 134 |
| | | | delaminated) | |
| WB-CAP3 | 0B | 0B | 334 | 136 |
| WB-CAP4 | 0B | 0B | 214 | 167 |
| WB-CAP5 | 0B | 0B | 229 | 221 |
| WB-CAP6 | 5B | 5B | 390 | 421 |
| WB-CAP7 | 5B | 5B | 365 | 395 |
| WB-CAP8 | 2B | 5B | 358 | 220 |
| WB-CAP9 | 2B | 5B | 251 | 197 |

### Example 11

### Melting and Curing Schedule of UV Curable Powder Coating:

UV curable powder was melted first at 120° C. for 3-4 minutes and then cured using conveyorized UV oven having medium pressure H-bulb in 2 passes with a total UV dosage of 3,451 mJ/cm².

### Example 12

A pull off adhesion test was carried out to determine interfacial adhesion. Multiple adhesion tests with 20 mm dollies were carried out to determine interface of the coating failure and the force/area at which failure happens. Dry film thickness of CAP and cured powder coating was measured using Positector B100, ultrasonic film thickness gauge. Table 4 summarizes the results of the pull off adhesion test.

TABLE 4
ASTM D4541 Positest AT-A Pull off adhesion test

| | Conduc- | DFT | DFT of | CAP/ | CAP/ | |
|---|---|---|---|---|---|---|
| | tivity | of | Powder | Sub- | Powder | |
| Sub- | agent | CAP | Coating | strate | coating | Type of |
| strate | loading (%) | (μ) | (μ) | interface | interface | failure |
| WPC | 0.33 | 11-25 | 51 | No failure | No failure | Cohesive, |
| | | | | | | powder |
| | | | | | | coating |
| PC/ | 0.33 | 10-25 | 45 | No failure | No failure | Cohesive, |
| ABS | | | | | | powder |
| | | | | | | coating |

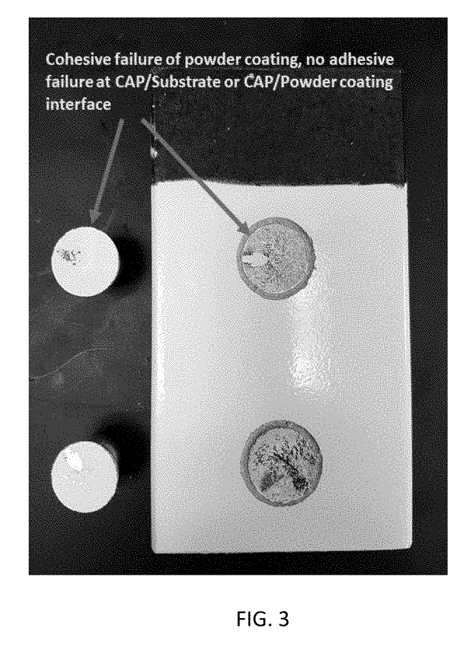

FIG. 3 illustrates the results of the pull off adhesion test showing cohesive failure of powder coating on wood-plastic composite after positest pull-off adhesion test. As shown in the figure there is cohesive failure of the powder coating, with no adhesive failure at the CAP/substrate or CAP/powder coating interface.

The foregoing description is illustrative of particular embodiments of the invention but is not meant to be a limitation upon the practice thereof. The following claims, including all equivalents thereof, are intended to define the scope of the invention.

1. A conductive substance for the promotion of adhesion of liquid and powder coatings to non-conductive substrates, comprising:
a solvent;
a chlorinated polyolefin dispersed in said solvent; and
conductive nanoparticulate dispersed in said solvent.

2. The conductive substance of claim 1 wherein further comprising an adhesion promoter for said chlorinated polyolefin.

3. The conductive substance of claim 1 wherein said conductive nanoparticulate comprises 0.2-0.6 total weight percent of multiwalled carbon nanotubes.

4. The conductive substance of claim 1 wherein conductive nanoparticulate comprises 0.05-0.33 total weight percent of single-walled carbon nanotubes.

5. The conductive substance of claim 1 wherein conductive nanoparticulate comprises up to 4 total weight percent of graphene.

6. The conductive substance of claim 1 further comprising a self crosslinkable polymer.

7. A process of applying a conductive adhesion promoter to a non-conductive substrate, the process comprising:
applying the conductive adhesion promoter of claim 1 to treat the non-conductive substrate and make a treated substrate with a surface resistivity of less than 10⁶ Ohm/Square; and
drying and curing the treated substrate at ambient temperature for 3-8 minutes.

8. The process of claim 7 wherein the non-conductive substrate is at least one of: wood-plastic composite, polycarbonate (PC), Polycarbonate (PC)/acrylonitrile butadiene styrene (ABS), particle board, laminated board, trim board, ceramic tiles, concrete, glass or medium-density fiberboard (MDF).

9. A dried film on a non-conductive substrate, the dried film having a thickness and comprising:
a cured matrix of chlorinated polyolefin; and
conductive particulate dispersed in said cured matrix.

10. The dried film of claim 9 wherein the thickness is between 4-25 microns.
